(19) United States
(12) Patent Application Publication
(10) Pub. No.: US 2016/0162918 A1
(43) Pub. Date: Jun. 9, 2016

(54) METHOD AND SYSTEM FOR IDENTIFYING GEOGRAPHIC-BASED LIFESTYLE INFORMATION

(71) Applicant: MasterCard International Incorporated, Purchase, NY (US)

(72) Inventors: Loralee BODO, Hawthorne, NY (US); Annemarie Swingle, New York, NY (US)

(21) Appl. No.: 14/564,585

(22) Filed: Dec. 9, 2014

(51) Int. Cl. G06Q 30/02

(52) U.S. Cl. CPC G06Q 30/0205

(57) ABSTRACT

A method for identifying geographic-based lifestyle groups includes: storing consumer profiles, each profile including data related to consumers including a geographic location and consumer characteristics and purchase behaviors; receiving a lifestyle group request, the request including a geographic indicator; identifying a plurality of geographic areas based on the geographic indicator; identifying a group of consumer profiles for each geographic area where the geographic location is included in the respective geographic area; identifying a consumer lifestyle for each geographic area based on a correspondence between consumer characteristics and/or purchase behaviors included in a lifestyle rule associated with the respective consumer lifestyle and the consumer characteristics and purchase behaviors included in each consumer profile in the area's group of consumer profiles; and transmitting data associated with the identified plurality of geographic areas and corresponding identified consumer lifestyle in response to the received lifestyle group request.

### FIELD

The present disclosure relates to identification of geographic-based lifestyle groups, specifically, the use of transaction data to identify lifestyles of consumers combined with geolocation data to identify consumer groups sharing lifestyles.

### BACKGROUND

Information about consumer can have a lot of value to merchants, advertisers, manufacturers, retailers, offer providers, content providers, etc. As an entity gains more knowledge about a consumer, the entity can better tailor content that is to be distributed to that consumer based on that gained knowledge. For example, if a deal provider learns that a particular consumer has a high interest in electronic goods, the deal provider may specifically identify deals on electronic goods for that consumer. Ideally, the targeting of content to a consumer based on their data can result in more effective content distribution, with a higher conversion rate or rate of return.

However, it is often not cost-effective for an entity to reach individual consumers. Instead, it can be beneficial for an entity to reach out to groups of consumers at once, particularly based on geographic location. For example, an advertisement visible from a busy thoroughfare can reach a significant number of consumers in a specific area. Similarly, the distribution of mailers to a neighborhood can be significantly easier and less expensive for an entity than the mailing of specific content items to specific, individual consumers.

However, many merchants, content providers, advertisers, and other entities lack both the knowledge required to identify consumer interests on such a scale, as well as technical systems able to gather and analyze such data. Thus, there is a need for a technical system that can analyze transaction data to identify consumer lifestyles, and also analyze the consumer lifestyle data and available geolocation data to identify lifestyle groups, which may identify groups that are highly suitable for the distribution of content by entities.

### SUMMARY

The present disclosure provides a description of systems and methods for identifying geographic-based lifestyle groups.

A method for identifying geographic-based lifestyle groups includes: storing, in a profile database, a plurality of consumer profiles, wherein each consumer profile includes data related to one or more consumers including at least a geographic location and one or more consumer characteristics and one or more purchase behaviors associated with each consumer of the related one or more consumers; receiving, by a receiving device, a lifestyle group request, wherein the lifestyle group request includes at least one geographic indicator; identifying, by a processing device, a plurality of geographic areas based on each of the at least one geographic indicator; identifying, by the processing device, a group of consumer profiles for each geographic area of the plurality of geographic areas where the geographic location included in each consumer profile of the respective group of consumer profiles is included in the respective geographic area; identifying, by the processing device, at least one consumer lifestyle for each geographic area of the plurality of geographic areas based on a correspondence between the one or more associated consumer characteristics and/or purchase behaviors included in a lifestyle rule associated with the respective consumer lifestyle and the one or more consumer characteristics and one or more purchase behaviors included in each consumer profile in the group of consumer profiles identified for the respective geographic area; and transmitting, by a transmitting device, data associated with the identified plurality of geographic areas and corresponding identified at least one consumer lifestyle in response to the received lifestyle group request.

A system for identifying geographic-based lifestyle groups includes a profile database, a receiving device, a processing device, and a transmitting device. The profile database is configured to store a plurality of consumer profiles, wherein each consumer profile includes data related to one or more consumers including at least a geographic location and one or more consumer characteristics and one or more purchase behaviors associated with each consumer of the related one or more consumers. The receiving device is configured to receive a lifestyle group request, wherein the lifestyle group request includes at least one geographic indicator. The processing device is configured to: identify a plurality of geographic areas based on each of the at least one geographic indicator; identify a group of consumer profiles for each geographic area of the plurality of geographic areas where the geographic location included in each consumer profile of the respective group of consumer profiles is included in the respective geographic area; and identify at least one consumer lifestyle for each geographic area of the plurality of geographic areas based on a correspondence between the one or more associated consumer characteristics and/or purchase behaviors included in a lifestyle rule associated with the respective consumer lifestyle and the one or more consumer characteristics and one or more purchase behaviors included in each consumer profile in the group of consumer profiles identified for the respective geographic area. The transmitting device is configured to transmit data associated with the identified plurality of geographic areas and corresponding identified at least one consumer lifestyle in response to the received lifestyle group request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for identifying geographic-based lifestyle groups in accordance with exemplary embodiments.

FIG. 2 is a block diagram illustrating the processing server 102 of FIG. 1 for the identification of consumer lifestyle groups in accordance with exemplary embodiments.

FIG. 3 is a flow diagram illustrating a process for identifying geographic-based lifestyle groups in accordance with exemplary embodiments.

FIG. 4 is a chart illustrating consumer purchase and geolocation data and use thereof in identifying a geographic-based lifestyle group in accordance with exemplary embodiments.

FIG. 5 is a diagram illustrating a map illustrating geographic-based lifestyle groups identified using the processing server of FIG. 2 in accordance with exemplary embodiments.

FIG. 6 is a flow chart illustrating an exemplary method for identifying geographic-based lifestyle groups in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal, etc.

### System for Identifying Geographic-Based Lifestyle Groups

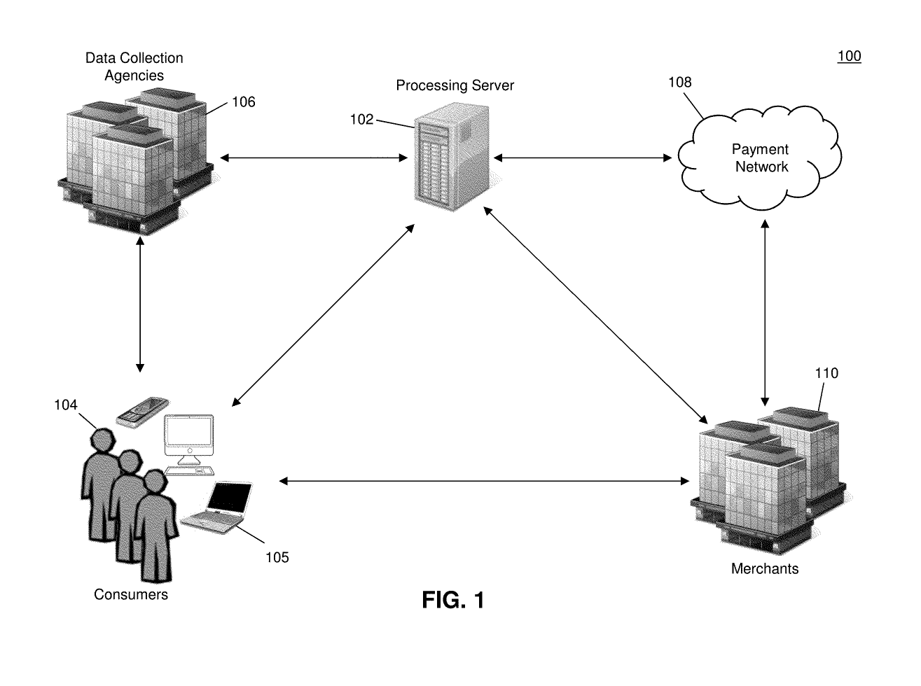

FIG. 1 illustrates a system 100 for identifying geographic-based lifestyle groups using transaction and geolocation data.

The system 100 may include a processing server 102. The processing server 102, discussed in more detail below, may be configured to identifying geographic-based lifestyle groups for a plurality of consumers 104. Geographic-based lifestyle groups may be groups of consumers 104 that live in a geographic area that each share a similar lifestyle, identified based on transaction data, as discussed in more detail below. In some instances, geographic-based lifestyle groups may overlap, and some consumers 104 may be included in multiple lifestyle groups.

The system 100 may include one or more data collection agencies 106. Each data collection agency 106 may be configured to collect geographic location (“geolocation”) data associated with each of the consumers 104. The geolocation data may be gathered via computing devices 105 associated with each consumer 104, or directly from each consumer 104 using methods and systems that will be apparent to persons having skill in the relevant art. For example, the data collection agencies 106 may survey the consumers 104 directly or via a telephone, e-mail, or Internet survey, the data collection agencies 106 may be mobile network operators that identify geographic locations of computing devices 105 that access their mobile network, such as cellular phones, smart phones, etc., or other suitable method.

The geolocation data may include any type of geographic location data suitable for use in performing the functions discussed herein, such as a zip code or postal code, a municipality, a street address, etc. In some instances, a street address may only be used with consent of the associated consumer 104. The data collection agencies 106 may collect the geographic location data and provide it to the processing server 102. The processing server 102 may then store the geographic location data in a profile associated with each consumer 104, as discussed in more detail below. In some embodiments, the processing server 102 may gather the geolocation data directly from the consumers 104, such as using the computing devise 105. For instance, the processing server 102 may survey the consumers 104 itself, may identify the geographic location of the computing devices 105, etc.

In addition to geolocation data, the processing server 102 may also obtain transaction data for the consumers 104. The transaction data may be provided to the processing server 102 by one or more payment networks 108. The payment networks 108 may collect transaction data during the processing of payment transactions involving the consumers 104 and one or more merchants 110. The payment network 108 may then transmit the transaction data to the processing server 102, for storage and use in identifying consumer lifestyle groups, as discussed in more detail below. In some embodiments, the processing server 102 may be a part of the payment network 108, and may thereby receive and store the transaction as part of the processing of payment transactions.

In some instances, transaction data and/or geolocation data obtained by the processing server 102 may be kept non-personally identifiable. For instance, the data may be associated with an identifying value that is associated with a consumer 104, such as a consumer identifier, but which is not personally identifiable to that consumer 104. For example, the consumer identifier may be a random number associated with a consumer 104, for which the processing server 102 may use to match geolocation and transaction data, without obtaining any information that is personally identifiable to the consumer 104. The protection of consumer privacy via the use of random values and/or encrypted values, such as a consumer identifier encrypted using a one-way method of encryption, will be apparent to persons having skill in the relevant art.

Once the processing server 102 has geolocation data and transaction data for each consumer, the processing server 102 may begin the identification of geographic-based lifestyle groups. The processing server 102 may calculate purchase behaviors for each of the consumers 104 for use in identifying their lifestyle(s). Purchase behaviors may be based on transaction data for one or more transactions involving a consumer 104 or a similar consumer 104, and may include, for example, propensities for the consumer 104 to spend across a plurality of categories. For instance, propensities may include a propensity to spend in a particular industry, on products in a particular category, at a particular merchant, at a particular geographic location, in a particular geographic area, during a particular period of time, and any combination thereof. Methods and algorithms used for calculating purchase behavior based on transaction data will be apparent to persons having skill in the relevant art. In some embodiments, the payment network 108 may provide purchase behavior directly to the processing server 102 instead of transaction data.

Once purchase behaviors for consumers 104 have been identified, the processing server may identify lifestyle groups associated with each consumer 104 based on their purchase behaviors. For example, a consumer 104 may be identified as being in a lifestyle group of wealthy travelers, of consumers that enjoy the nightlife, of working professionals, of large families, etc. Lifestyle groups that may be identified may be based on application, specified by an entity requesting lifestyle group data, etc. In instances where a large number of purchase behaviors may be identified for consumers 104, a vast number of lifestyle groups may be available for use. The creation of lifestyle groups and identification of purchase behaviors associated thereof will be apparent to persons having skill in the relevant art.

In some embodiments, consumer lifestyles may also be identified based on one or more consumer characteristics associated with each consumer 104 in addition to purchase behaviors. Consumer characteristics may include demographic, financial, or other suitable type of characteristics associated with a consumer 104, such as age, gender, income, residential status, marital status, familial status, education, occupation, etc. In some instances, the consumer characteristics may be bucketed, encrypted, or otherwise obscured using known methods and systems such that the associated consumer 104 is not personally identifiable. In some embodiments, consumers 104 may be grouped together with other consumers having similar consumer characteristics and/or transaction data such that no consumer 104 in a group of consumers is personally identifiable.

Once lifestyles have been associated with consumers 104, the processing server 102 may identify groups of consumers that share a common lifestyle and who have the same geolocation or a geolocation in a common geographic area. Geographic locations and geographic areas may be based on any suitable criteria, such as a postal code or zip code, municipality, school districts, zoning districts, voting districts, watersheds, fault lines, roads, neighborhoods, etc. For example, the processing server 102 may identify lifestyle groups for consumers 104 for each school district in city or county.

In some embodiments, consumer lifestyle groups may be requested by an entity, such as a merchant 110, for use in consumer targeting. The merchant 110 may supply the processing server 102 with data for use in identifying geographic-based consumer lifestyle groups. The data may include a geographic area for which the information is requested, specific consumer lifestyle groups the merchant 110 wants identified, the criteria used for division of the geographic area, etc. For example, a merchant 110 may want consumer lifestyle groups identified for each neighborhood in a county among the lifestyles of tech savvy and fashionistas. The processing server 102 may thus identify consumers 104 that match one of the two lifestyles, and then identify a lifestyle group of the two for each neighborhood in the county based on the lifestyles of the consumers 104 included therein.

Once the requested information has been identified, the processing server 102 may return the information to the merchant 110. In some instances, the processing server 102 may generate a map of the geographic area that illustrates the consumer lifestyle groups. For example, the map may be a geographical map of the area with the lifestyle groups and area lines illustrated. In another example, the map may be a heatmap, with the heat indicating the proportion of consumers at the given geographic location with a specific lifestyle group. In some cases, a heatmap may be generated for each lifestyle group. Additional types of maps that may be identified by the processing server 102 will be apparent to persons having skill in the relevant art.

The merchant 110 may then use the information for use in advertising, content distribution, offer distribution, etc. For instance, the information identified by the processing server 102 may indicate that a particular neighborhood is associated with the tech savvy lifestyle, and thus the merchant 110 may advertise to that neighborhood accordingly.

The methods and systems discussed herein thereby enable merchants 110, advertisers, and other entities to receive geographic-based consumer lifestyle information that may be otherwise unavailable for the entities to both obtain and analyze. The information may be very beneficial for targeting, content distribution, etc. as it may provide valuable consumer lifestyle information that is associated with geographic-based consumer groups, which may enable content distribution at a reduced cost with increased effectiveness. Such information may be valuable to a vast number of entities. For example, realtors and consumers 104 that are looking for a home may be able to identify the lifestyles of consumers in particular neighborhoods or areas, so that a consumer 104 can find a neighborhood with a lot of like-minded people. In another example, a business may identify the lifestyle groups in geographic areas where they are looking to expand, to find an ideal location, such as one that is associated with the business's ideal clientele. Additional uses and advantages of the methods and systems discussed herein will be apparent to persons having skill in the relevant art.

### Processing Server

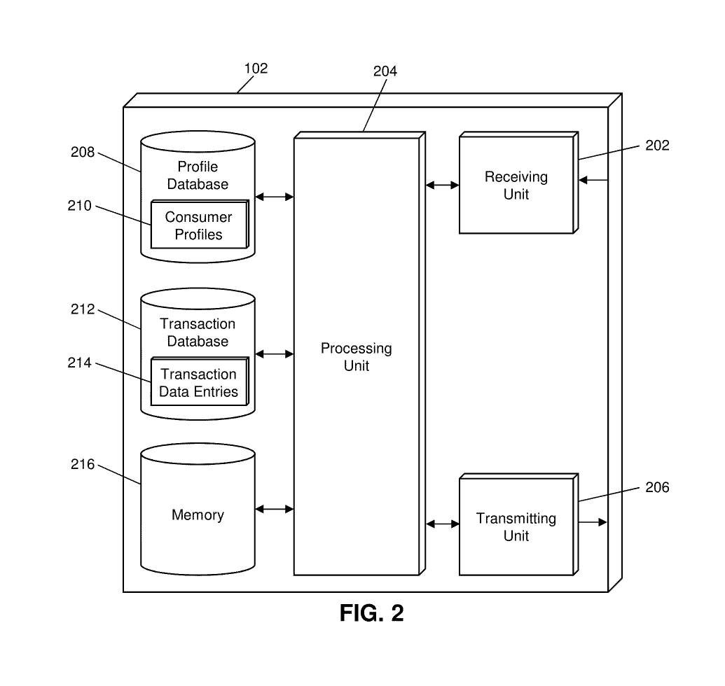

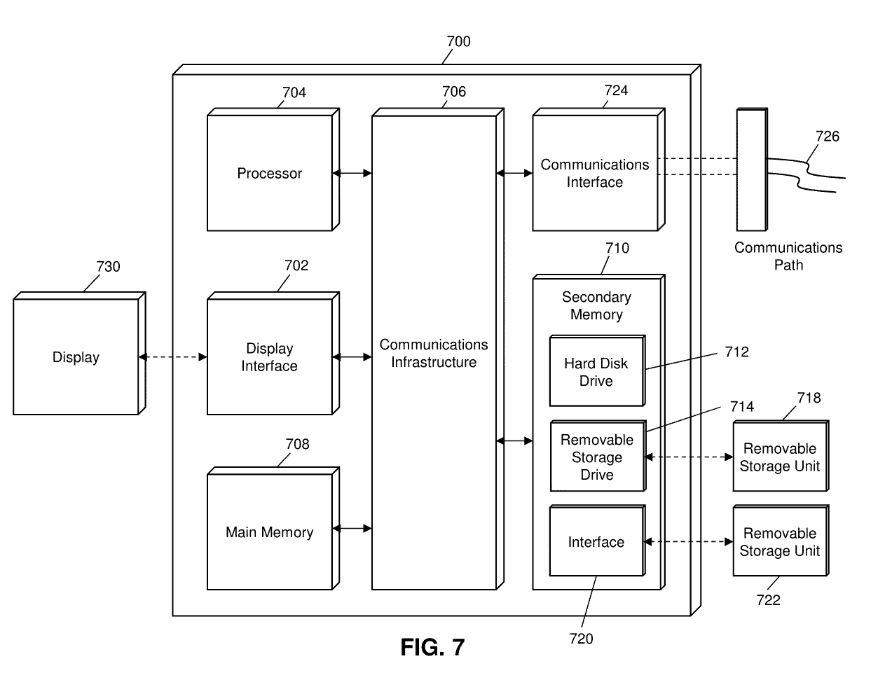

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving unit 202. The receiving unit 202 may be configured to receive data over one or more networks via one or more network protocols. The receiving unit 202 may receive geographic location data for consumers from data collection agencies 106, consumers 104, or other suitable sources. The receiving unit 202 may also receive transaction data for a plurality of payment transactions involving consumers 104, such as from the payment network 108, merchants 110, consumers 104, etc.

The geographic location data may be stored in a profile database 208 of the processing server 102. The profile database 208 may include a plurality of consumer profiles 210. Each consumer profile 210 may include data related to a consumer 104 including at least a consumer identifier, one or more purchase behaviors, and one or more consumer characteristics. The consumer identifier may be a unique value associated with the related consumer 104 and/or the consumer profile 210 for identification thereof, such as an identification number, a reference number, a transaction account number, a telephone number, a device identifier (e.g., associated with an associated computing device 105), a street address, or other suitable value.

The one or more consumer characteristics may be one or more characteristics associated with the related consumer 104, such as demographic characteristics. The one or more purchase behaviors may be purchase behaviors associated with the related consumer 104, identified based on transaction data of payment transactions involving the related consumer 104. In one embodiment, the purchase behavior(s) may be received by the receiving unit 202.

The processing server 102 may also include a transaction database 212. The transaction database 212 may include a plurality of transaction data entries 214. Each transaction data entry may include transaction data related to a payment transaction, which may include a consumer identifier associated with the consumer 104 involved in the transaction, a transaction amount, a transaction time and/or date, a geographic location, merchant data, product data, point of sale data, offer data, etc. The transaction data stored in the transaction data entries 214 may be received by the receiving unit 202, such as from the payment network 108.

The processing server 102 may further include a processing unit 204. The processing unit 204 may be configured to perform the functions of the processing server 102 discussed herein, as will be apparent to persons having skill in the relevant art. The processing unit 204 may analyze the transaction data entries 214 related to payment transactions involving a specific consumer 104 and calculate purchase behaviors for that consumer 104 based thereon. The processing unit 204 may then store the calculated purchase behaviors in the consumer profile 210 in the profile database 208 associated with that consumer 104.

The processing server 102 may also include a memory 216. The memory 216 may be configured to store data suitable for performing the functions of the processing server 102 discussed herein. For example, the memory 216 may store geographic location and/or area information, rules and algorithms for calculating purchase behaviors, purchase behaviors and/or consumer characteristics for lifestyle groups, rules and algorithms for the generation of lifestyle group maps, etc. Additional data that may be stored in the memory 216 will be apparent to persons having skill in the relevant art.

The processing unit 204 may be configured to identify groups of consumer profiles 210 that have a geographic location included in a geographic area. The geographic area may be based on data received by the receiving unit 202 in a request for lifestyle groups. For example, the geographic area may be a city, county, neighborhood, shopping center, school district, etc. The processing unit 204 may identify the group of consumer profiles 210, and may then identify one or more consumer lifestyles for that geographic area. The identified consumer lifestyles may be based on consumer lifestyles associated with each consumer profile 210 in the group, which may be identified based on the purchase behaviors and/or consumer characteristics included in the respective consumer profile 210. Correspondence between purchase behaviors and/or consumer characteristics and a consumer lifestyle may be based on rules stored in the memory 216. For instance, a rule may indicate that consumer profiles that have a high propensity to purchase electronic items and have at least an undergraduate level or higher education may be indicated as having a tech savvy professional lifestyle.

The processing unit 204 may be further configured to generate maps based on identified lifestyle groups. Maps may be physical image maps, heatmaps, or any other suitable illustrative representation of one or more geographic areas and the associated consumer lifestyle groups. In some embodiments, the processing server 102 may also include a transmitting unit 206. The transmitting unit 206 may be configured to transmit data over one or more networks via one or more network protocols. The transmitting unit 206 may transmit generated maps and/or lifestyle group data to a third party, such as a merchant 110 or an entity that requested a map or lifestyle group data. For example, a merchant 110 may request a list of consumer lifestyle groups for a plurality of surrounding geographic areas.

It will be apparent to persons having skill in the relevant art that, in some embodiments, the processing server 102 may include additional components and/or that the components of the processing server 102 illustrated in FIG. 2 and discussed herein may be further configured to perform additional functions. For instance, in embodiments where the processing server 102 is part of a payment network 108 or data collection agency 106, such as a mobile network operator, the components of the processing server 102 may be further configured to perform the traditional functions of such an entity, such as the processing of payment transactions or the handling of telephone calls or other data transmission.

### Process for Identifying Lifestyle Groups

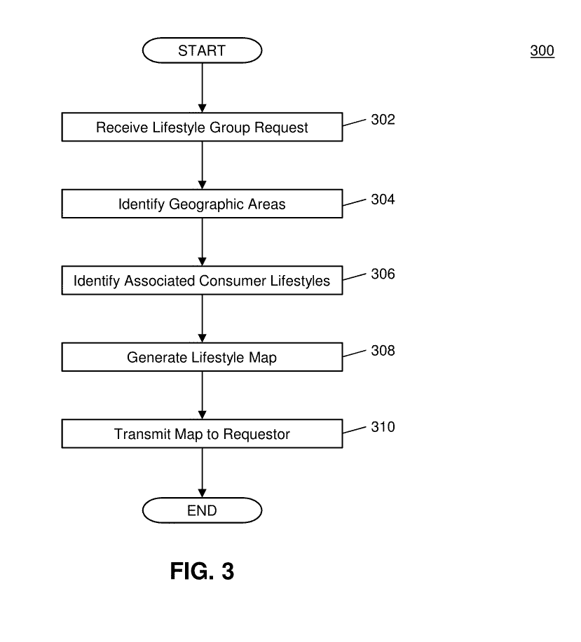

FIG. 3 illustrates a process 300 for the identification of geographic-based consumer lifestyle groups using transaction data and consumer characteristics.

In step 302, the receiving unit 202 of the processing server 102 may receive a lifestyle group request. The lifestyle group request may include at least a geographic indicator. The geographic indicator may correspond to a geographic area and/or may indicate the type of geographic area for which consumer lifestyle groups are requested, such as school districts. In some instances, the geographic indicator may include an overall geographic area, from which sub-areas are to be used for identification of lifestyle groups. For example, a consumer 104 may request lifestyle groups for various school districts inside of a specific county.

In step 304, the processing unit 204 of the processing server 102 may identify geographic areas for which lifestyle groups are to be identified based on the received geographic indicator. For instance, the processing unit 204 may identify a plurality of geographic areas in the memory 216 associated with the received geographic indicator. In an example, the geographic indicator may be for a neighborhood breakdown of consumer lifestyles in a specific county, with the memory 216 storing the neighborhoods and associated geographic locations in that county for use by the processing unit 204.

In step 306, the processing unit 204 may identify the consumer lifestyles associated with each identified geographic area. Identification of the associated consumer lifestyles may include identifying consumer profiles 210 stored in the profile database 208 that include a geographic location included in each respective geographic area, and identification of consumer lifestyles associated thereof based on the included purchase behaviors and consumer characteristics. The consumer lifestyle identified for each geographic area may be based on a frequency of each consumer lifestyle among the consumer profiles 210 identified for that respective geographic area. In some instances, multiple consumer lifestyles may be identified for a geographic area. For example, the processing unit 204 may identify a consumer lifestyle as being associated with a geographic area if a predetermined number of consumers 104 (e.g., 33%) in the geographic area are associated with that lifestyle.

In some embodiments, the lifestyle group request may specify one or more consumer lifestyles. In such an embodiment, the processing unit 204 may identify consumer profiles 210 included in each geographic area that match a specified consumer lifestyle, or may identify a specified consumer lifestyle that is the closest match for each consumer profile 210 in the geographic area. In such an instance, the consumer lifestyles associated with each geographic area may be one of the consumer lifestyles specified by the requestor, which may result in a specialized, custom map or other representation of consumer lifestyle groups.

In step 308, the processing unit 204 may generate a lifestyle map that includes each geographic area and the associated consumer lifestyle(s). In some embodiments, the type of map or data representation generated by the processing unit 204 may be specified in the lifestyle group request received by the receiving unit 202. For instance, the requestor may request individual heatmaps for each consumer lifestyle identified for the geographic area. In some instances, the data representation may be a list, such as a list of geographic areas and associated consumer lifestyles. In step 310, the transmitting unit 306 of the processing server 102 may transmit the generated map to the requestor as a response to the received lifestyle group request.

### Identification of Consumer Lifestyles and Lifestyle Groups

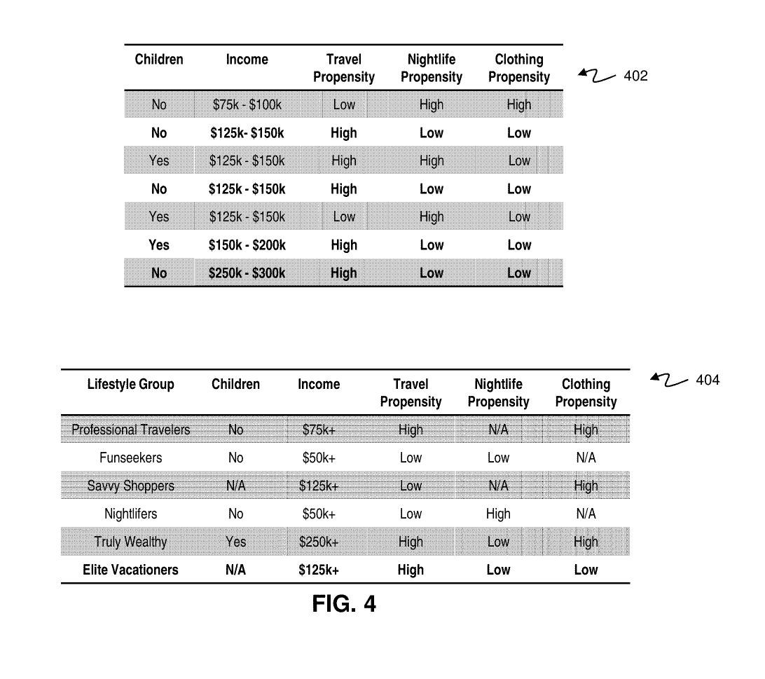

FIG. 4 illustrates the identification of consumer lifestyles for consumer profiles 210 and use thereof to identify a lifestyle group for a geographic area.

Table 402 of FIG. 4 includes a plurality of consumer profiles 210. Each consumer profile 210 is related to a consumer 104 in a specific geographic area, such as being in a particular school district or zip code. Each consumer profile 210 in table 402 includes two consumer characteristics, existence of children and an income range, and three purchase behaviors, a propensity to spend across travel, nightlife, and clothing. As illustrated in FIG. 4, the consumer profiles 210 may not include any personally identifiable information.

Table 404 includes a plurality of consumer lifestyles, such as could be stored in the memory 216 of the processing server 102. Each consumer lifestyle has associated values of the two consumer characteristics and three purchase behaviors. For example, a consumer 104 may be considered to be living a savvy shopper lifestyle if they make more than $125,000 a year, have a low propensity to travel, and a high propensity to purchase clothing. The value of “N/A” for children indicates that a consumer 104 may be considered to be a savvy shopper regardless of whether or not they have children. In some instances, consumer lifestyles may be such that a consumer 104 may be associated with more than one consumer lifestyle. For instance, a consumer 104 that does not have children, makes more than $125,000, has a low propensity to travel and experience the nightlife, and a high propensity to purchase clothing can be considered to be both a funseeker and a savvy shopper.

In the example illustrated in FIG. 4, the processing unit 204 may identify a consumer lifestyle associated with each of the consumer profiles 210 in the geographic area, and may then identify a consumer lifestyle group for the geographic area based thereon. In the illustrated example, four of the consumer profiles 210 are associated with the elite vacationers lifestyle, due to the income consumer characteristic and the three purchase behaviors. As a result, the processing unit 204 may identify the elite vacationers consumer lifestyle with the geographic area to which the consumer profiles 210 in the table 402 are associated.

### Lifestyle Group Map

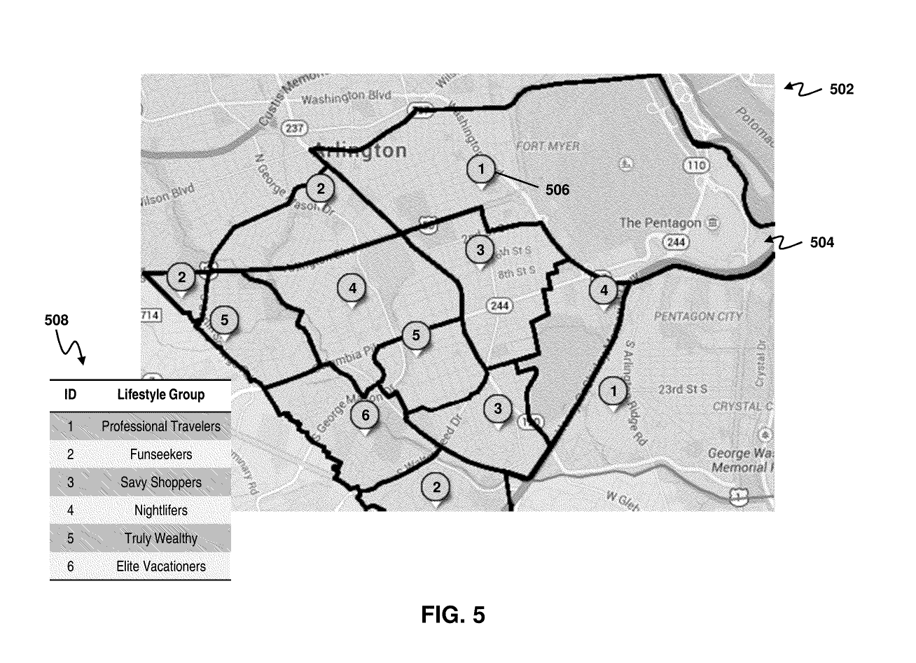

FIG. 5 illustrates a map representation of consumer lifestyle groups for geographic areas.

As illustrated in FIG. 5, a map 502 for an overall geographic area may be produced, such as based on the geographic indicator or other information included in a received lifestyle group request. For instance, the geographic indicator may indicate the overall area to which the map 502 is to correspond. In another example, the area of the map 502 may be identified by the processing unit 204 in order to encompass each geographic area for which a lifestyle group is identified.

The map 502 may include a plurality of geographic areas 504. Each geographic area 504 is indicated via the boundary lines on the map 502 and may correspond to any suitable type of area. In the example illustrated in FIG. 5, each geographic area 504 corresponds to a school district.

The map 502 may also include a lifestyle group indicator 506 for each of the geographic areas 504. The lifestyle group indicator 506 may include a value indicative of the lifestyle group associated with the respective geographic area 504 as identified by the processing unit 204. In the example illustrated in FIG. 5, a legend 508 indicates the lifestyle group that corresponds to each lifestyle group indicator 506. In the illustrated example, the legend 508 includes each of the lifestyles included in table 404 of FIG. 4, with each consumer lifestyle being associated with one or more geographic areas 504 in the map 502.

### Exemplary Method for Identifying Geographic-Based Lifestyle Groups

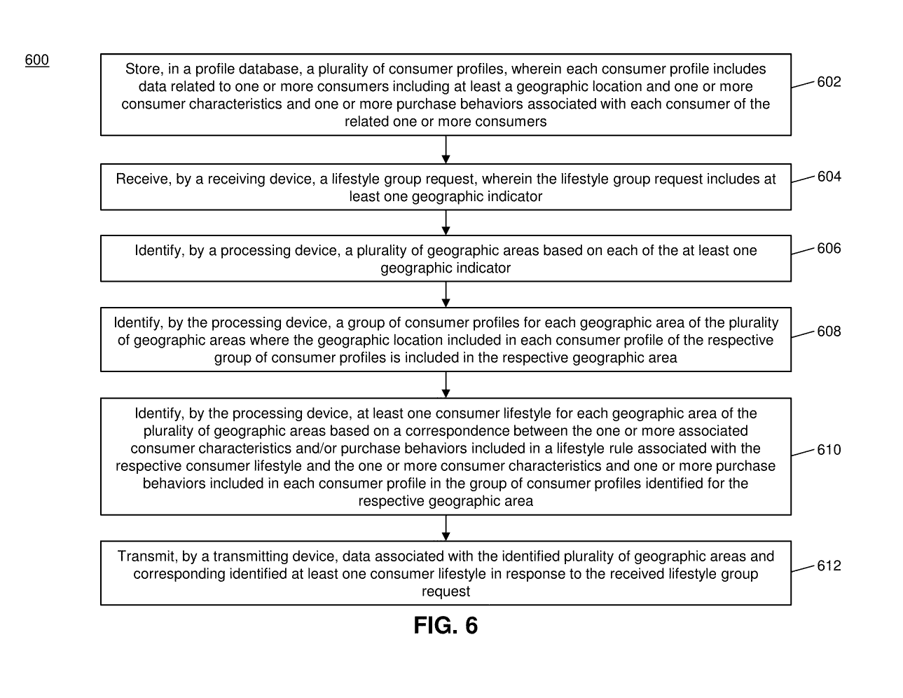

FIG. 6 illustrates a method 600 for identifying geographic-based lifestyle groups based on transaction data and consumer characteristics.

In step 602, a plurality of consumer profiles (e.g., consumer profiles 210) may be stored in a profile database (e.g., the profile database 208), wherein each consumer profile 210 includes data related to one or more consumers (e.g., consumer 104) including at least a geographic location and one or more consumer characteristics and one or more purchase behaviors associated with each consumer 104 of the related one or more consumers. In step 604, a lifestyle group request may be received by a receiving device (e.g., the receiving unit 202), wherein the lifestyle group request includes at least one geographic indicator.

In step 606, a plurality of geographic areas may be identified by a processing device (e.g., the processing unit 204) based on each of the at least one geographic indicators. In some embodiments, the at least one geographic indicator includes at least one of: a geographic location, a geographic area, one or more municipalities, one or more school districts, and a distance to a geographic location. In step 608, a group of consumer profiles 210 may be identified by the processing unit 204 for each geographic area of the plurality of geographic areas where the geographic location included in each consumer profile 210 of the respective group of consumer profiles is included in the respective geographic area.

In step 610, at least one consumer lifestyle may be identified by the processing unit 204 for each geographic area of the plurality of geographic areas based on a correspondence between the one or more associated consumer characteristics and/or purchase behaviors included in a lifestyle rule associated with the respective consumer lifestyle and the one or more consumer characteristics and one or more purchase behaviors included in each consumer profile 210 in the group of consumer profiles identified for the respective geographic area. In step 612, a transmitting device (e.g., the transmitting unit 206) may transmit data associated with the identified plurality of geographic areas and corresponding identified at least one consumer lifestyle in response to the received lifestyle group request.

In one embodiment, the method 600 may further include: storing, in a transaction database (e.g., the transaction database 212), a plurality of transaction data entries (e.g., transaction data entries 214), wherein each transaction data entry 214 includes data related to a payment transaction including at least a consumer identifier associated with a consumer 104 involved in the related payment transaction and transaction data; and identifying, by the processing device, the one or more purchase behaviors included in each consumer profile 210 based on the transaction data included in each transaction data entry 214 stored in the transaction database 212 that includes a consumer identifier associated with a consumer 104 included in the one or more consumers 104 related to the respective consumer profile 210.

In some embodiments, the method 600 may also include generating, by the processing unit 204, a heatmap of a geographic region: wherein the geographic region includes each of the plurality of geographic areas; the heatmap illustrates a density of consumers 104 associated with the consumer lifestyle identified for each of the plurality of geographic areas; and the density of consumers 104 is based on a number of consumer profiles 210 or a number of consumers 104 related to consumer profiles 210 included in the identified group of consumer profiles for the respective geographic area where the included one or more consumer characteristics and one or more purchase behaviors correspond to the one or more associated consumer characteristics and/or purchase behaviors included in the lifestyle rule associated with the associated consumer lifestyle. In a further embodiment, transmitting data associated with the identified plurality of geographic areas and corresponding identified at least one consumer lifestyle includes transmitting the generated heatmap.

In one embodiment, the method 600 may further include: generating, by the processing device, a map of a geographic region including each of the plurality of geographic areas; and illustrating, by the processing device, each geographic area of the plurality of geographic areas and the corresponding at least one consumer lifestyle on the generated map. In a further embodiment, transmitting data associated with the identified plurality of geographic areas and corresponding identified at least one consumer lifestyle includes transmitting the generated map.

In some embodiments, the method 600 may also include storing, in a memory (e.g., the memory 216), one or more lifestyle rules, wherein each lifestyle rule is associated with a consumer lifestyle and includes one or more associated consumer characteristics and/or purchase behaviors, wherein the at least one consumer lifestyle identified for each geographic area of the plurality of geographic areas is based on the one or more lifestyle rules stored in the memory 216. In a further embodiment, the lifestyle group request may further include one or more lifestyle rules, and the at least one consumer lifestyle identified for each geographic area of the plurality of geographic areas is based on the one or more lifestyle rules stored in the memory 216.

In one embodiment, the lifestyle group request may further include one or more consumer lifestyles, and the method 600 may further include identifying, by the processing unit 204, a lifestyle rule associated with each consumer lifestyle included in the received lifestyle group request, wherein each identified lifestyle rule includes one or more consumer characteristics and/or purchase behaviors associated with the respective consumer lifestyle, wherein the at least one consumer lifestyle identified for each geographic area of the plurality geographic areas is based on the identified lifestyle rules.

In some embodiments, the method 600 may also include storing, in the memory 216, a plurality of lifestyle rules, wherein each lifestyle rule is associated with a consumer lifestyle and includes one or more associated consumer characteristics and/or purchase behaviors, and wherein the lifestyle group request further includes a plurality of consumer lifestyles and the at least one consumer lifestyle identified for each geographic area of the plurality of geographic areas is included in the plurality of consumer lifestyles and is based on the corresponding lifestyle rule stored in the memory 216 that is associated with the respective consumer lifestyle.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3 and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for identifying geographic-based lifestyle groups. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying geographic-based lifestyle groups, comprising:
storing, in a profile database, a plurality of consumer profiles, wherein each consumer profile includes data related to one or more consumers including at least a geographic location and one or more consumer characteristics and one or more purchase behaviors associated with each consumer of the related one or more consumers;
receiving, by a receiving device, a lifestyle group request, wherein the lifestyle group request includes at least one geographic indicator;
identifying, by a processing device, a plurality of geographic areas based on each of the at least one geographic indicator;
identifying, by the processing device, a group of consumer profiles for each geographic area of the plurality of geographic areas where the geographic location included in each consumer profile of the respective group of consumer profiles is included in the respective geographic area;
identifying, by the processing device, at least one consumer lifestyle for each geographic area of the plurality of geographic areas based on a correspondence between the one or more associated consumer characteristics and/or purchase behaviors included in a lifestyle rule associated with the respective consumer lifestyle and the one or more consumer characteristics and one or more purchase behaviors included in each consumer profile in the group of consumer profiles identified for the respective geographic area; and
transmitting, by a transmitting device, data associated with the identified plurality of geographic areas and corresponding identified at least one consumer lifestyle in response to the received lifestyle group request.

2. The method of claim 1, further comprising:
storing, in a transaction database, a plurality of transaction data entries, wherein each transaction data entry includes data related to a payment transaction including at least a consumer identifier associated with a consumer involved in the related payment transaction and transaction data; and
identifying, by the processing device, the one or more purchase behaviors included in each consumer profile based on the transaction data included in each transaction data entry stored in the transaction database that includes a consumer identifier associated with a consumer included in the one or more consumers related to the respective consumer profile.

3. The method of claim 1, wherein the at least one geographic indicator includes at least one of: a geographic location, a geographic area, one or more municipalities, one or more school districts, and a distance to a geographic location.

4. The method of claim 1, further comprising:
generating, by the processing device, a heatmap of a geographic region, wherein
the geographic region includes each of the plurality of geographic areas,
the heatmap illustrates a density of consumers associated with the consumer lifestyle identified for each of the plurality of geographic areas, and
the density of consumers is based on a number of consumer profiles or a number of consumers related to consumer profiles included in the identified group of consumer profiles for the respective geographic area where the included one or more consumer characteristics and one or more purchase behaviors correspond to the one or more associated consumer characteristics and/or purchase behaviors included in the lifestyle rule associated with the associated consumer lifestyle.

5. The method of claim 4, wherein transmitting data associated with the identified plurality of geographic areas and corresponding identified at least one consumer lifestyle includes transmitting the generated heatmap.

6. The method of claim 1, further comprising:
generating, by the processing device, a map of a geographic region including each of the plurality of geographic areas; and
illustrating, by the processing device, each geographic area of the plurality of geographic areas and the corresponding at least one consumer lifestyle on the generated map.

7. The method of claim 6, wherein transmitting data associated with the identified plurality of geographic areas and corresponding identified at least one consumer lifestyle includes transmitting the generated map.

8. The method of claim 1, further comprising:
storing, in a memory, one or more lifestyle rules, wherein each lifestyle rule is associated with a consumer lifestyle and includes one or more associated consumer characteristics and/or purchase behaviors, wherein
the at least one consumer lifestyle identified for each geographic area of the plurality of geographic areas is based on the one or more lifestyle rules stored in the memory.

9. The method of claim 8, wherein
the lifestyle group request further includes one or more lifestyle rules, and
the at least one consumer lifestyle identified for each geographic area of the plurality of geographic areas is based on the one or more lifestyle rules stored in the memory.

10. The method of claim 1, wherein the lifestyle group request further includes one or more consumer lifestyles, and the method further comprises:
identifying, by the processing device, a lifestyle rule associated with each consumer lifestyle included in the received lifestyle group request, wherein each identified lifestyle rule includes one or more consumer characteristics and/or purchase behaviors associated with the respective consumer lifestyle, wherein
the at least one consumer lifestyle identified for each geographic area of the plurality of geographic areas is based on the identified lifestyle rules.

11. The method of claim 1, further comprising:
storing, in a memory, a plurality of lifestyle rules, wherein each lifestyle rule is associated with a consumer lifestyle and includes one or more associated consumer characteristics and/or purchase behaviors, wherein
the lifestyle group request further includes a plurality of consumer lifestyles, and
the at least one consumer lifestyle identified for each geographic area of the plurality of geographic areas is included in the plurality of consumer lifestyles and is based on the corresponding lifestyle rule stored in the memory that is associated with the respective consumer lifestyle.

12. A system for identifying geographic-based lifestyle groups, comprising:
a profile database configured to store a plurality of consumer profiles, wherein each consumer profile includes data related to one or more consumers including at least a geographic location and one or more consumer characteristics and one or more purchase behaviors associated with each consumer of the related one or more consumers;
a receiving device configured to receive a lifestyle group request, wherein the lifestyle group request includes at least one geographic indicator;
a processing device configured to
identify a plurality of geographic areas based on each of the at least one geographic indicator,
identify a group of consumer profiles for each geographic area of the plurality of geographic areas where the geographic location included in each consumer profile of the respective group of consumer profiles is included in the respective geographic area, and
identify at least one consumer lifestyle for each geographic area of the plurality of geographic areas based on a correspondence between the one or more associated consumer characteristics and/or purchase behaviors included in a lifestyle rule associated with the respective consumer lifestyle and the one or more consumer characteristics and one or more purchase behaviors included in each consumer profile in the group of consumer profiles identified for the respective geographic area; and
a transmitting device configured to transmit data associated with the identified plurality of geographic areas and corresponding identified at least one consumer lifestyle in response to the received lifestyle group request.

13. The system of claim 12, further comprising:
a transaction database configured to store a plurality of transaction data entries, wherein each transaction data entry includes data related to a payment transaction including at least a consumer identifier associated with a consumer involved in the related payment transaction and transaction data, wherein
the processing device is further configured to identify the one or more purchase behaviors included in each consumer profile based on the transaction data included in each transaction data entry stored in the transaction database that includes a consumer identifier associated with a consumer included in the one or more consumers related to the respective consumer profile.

14. The system of claim 12, wherein the at least one geographic indicator includes at least one of: a geographic location, a geographic area, one or more municipalities, one or more school districts, and a distance to a geographic location.

15. The system of claim 12, wherein
the processing device is further configured to generate a heatmap of a geographic region,
the geographic region includes each of the plurality of geographic areas,
the heatmap illustrates a density of consumers associated with the consumer lifestyle identified for each of the plurality of geographic areas, and
the density of consumers is based on a number of consumer profiles or a number of consumers related to consumer profiles included in the identified group of consumer profiles for the respective geographic area where the included one or more consumer characteristics and one or more purchase behaviors correspond to the one or more associated consumer characteristics and/or purchase behaviors included in the lifestyle rule associated with the associated consumer lifestyle.

16. The system of claim 15, wherein transmitting data associated with the identified plurality of geographic areas and corresponding identified at least one consumer lifestyle includes transmitting the generated heatmap.

17. The system of claim 12, wherein the processing device is further configured to
generate a map of a geographic region including each of the plurality of geographic areas, and
illustrate each geographic area of the plurality of geographic areas and the corresponding at least one consumer lifestyle on the generated map.

18. The system of claim 17, wherein transmitting data associated with the identified plurality of geographic areas and corresponding identified at least one consumer lifestyle includes transmitting the generated map.

19. The system of claim 12, further comprising:
a memory configured to store one or more lifestyle rules, wherein each lifestyle rule is associated with a consumer lifestyle and includes one or more associated consumer characteristics and/or purchase behaviors, wherein
the at least one consumer lifestyle identified for each geographic area of the plurality of geographic areas is based on the one or more lifestyle rules stored in the memory.

20. The system of claim 19, wherein
the lifestyle group request further includes one or more lifestyle rules, and
the at least one consumer lifestyle identified for each geographic area of the plurality of geographic areas is based on the one or more lifestyle rules stored in the memory.

21. The system of claim 12, wherein
the lifestyle group request further includes one or more consumer lifestyles,
the processing device is further configured to identify a lifestyle rule associated with each consumer lifestyle included in the received lifestyle group request, wherein each identified lifestyle rule includes one or more consumer characteristics and/or purchase behaviors associated with the respective consumer lifestyle, and
the at least one consumer lifestyle identified for each geographic area of the plurality of geographic areas is based on the identified lifestyle rules.

22. The system of claim 12, further comprising:
a memory configured to store a plurality of lifestyle rules, wherein each lifestyle rule is associated with a consumer lifestyle and includes one or more associated consumer characteristics and/or purchase behaviors, wherein
the lifestyle group request further includes a plurality of consumer lifestyles, and
the at least one consumer lifestyle identified for each geographic area of the plurality of geographic areas is included in the plurality of consumer lifestyles and is based on the corresponding lifestyle rule stored in the memory that is associated with the respective consumer lifestyle.
